(19) United States
(12) Patent Application Publication
(10) Pub. No.: US 2002/0075636 A1
(43) Pub. Date: Jun. 20, 2002

(54) PERSONAL COMPUTER WITH RETRACTABLE SPEAKERS

(76) Inventor: HIDETAKA UMETSU, YAMAGATA (JP)

Correspondence Address: FOLEY & LARNDER, WASHINGTON HARBOUR, SUITE 500, 3000 K STREET NW, WASHINGTON, DC, 200075109

(21) Appl. No.: 09/453,399

(22) Filed: Dec. 3, 1999

(30) Foreign Application Priority Data
Mar. 12, 1998 (JP) 10-343845

(51) Int. Cl. G06F 1/16

(52) U.S. Cl. 361/683

(57) ABSTRACT

A personal computer (PC) of the present invention includes retractable speakers and allows them to be adjusted to a desired angular position by hand. The speakers can therefore be mounted on the PC face up and promote the thin configuration of the PC without regard to their diameter.

### BACKGROUND OF THE INVENTION

The present invention relates to a personal computer including speakers and more particularly to a personal computer with retractable speakers.

Generally, many of conventional personal computers including laptop and notebook-sized personal computers are provided with two speakers. Specifically, two speakers are mounted on opposite sides (right and left) of a screen included in a personal computer or mounted on the body of a personal computer. Today, however, it is difficult to provide the screen side with a space great enough to accommodate two speakers due to the increasing size of an LCD (Liquid Crystal Display) panel.

In light of the above, most of recent personal computers are provided with speakers in their bodies. The speakers built in the body of a personal computer are fixedly positioned such that they output sound either upward or frontward, considering a space available in the body, function, etc. However, the speakers facing upward are apt to gather dust when left unused over a long time. Moreover, when the operator of the personal computer touches both the top and front of the body while uttering a speech, the operator's hands are apt to stop holes formed in the body in alignment with the speakers. When the speakers face frontward for a thin configuration, the diameter of the speakers applicable to the personal computer is limited. This prevents speakers of high sound quality from being built in the personal computer.

Technologies relating to the present invention are disclosed in, e.g., Japanese Utility Model Laid-Open Publication No. 5-30949, Japanese Utility Model Publication Nos. 3019791 and 3044340, and Japanese Patent Laid-Open Publication Nos. 9-120354, 9-311776, and 10-63474.

### SUMMARY OF THE INVENTION

It is therefore an object of the present invention to provide a personal computer with speakers that are retractable and tiltable to a desired angle.

A personal computer with a speaker of the present invention includes a body, a speaker storing section formed in the body for receiving the speaker, a hinge unit retractable into the speaker storing section, and a speaker unit including the speaker and connected to the hinge unit by a hinge mechanism such that the speaker is retractable into the speaker storing section together with the hinge unit.

### BRIEF DESCRIPTION OF THE DRAWINGS

The above and other objects, features and advantages of the present invention will become more apparent from the following detailed description taken with the accompanying drawings in which:

FIG. 1 is an isometric view showing a personal computer embodying the present invention;

FIGS. 2 and 3 are isometric views respectively showing a speaker unit included in the illustrative embodiment in a retracted position and an extended position;

FIG. 4 is an isometric view showing how the speaker unit is adjustable in angle;

FIG. 5 is an isometric view showing an alternative embodiment of the present invention; and

FIG. 6 is an isometric view showing another alternative embodiment of the present invention.

### DESCRIPTION OF THE PREFERRED EMBODIMENTS

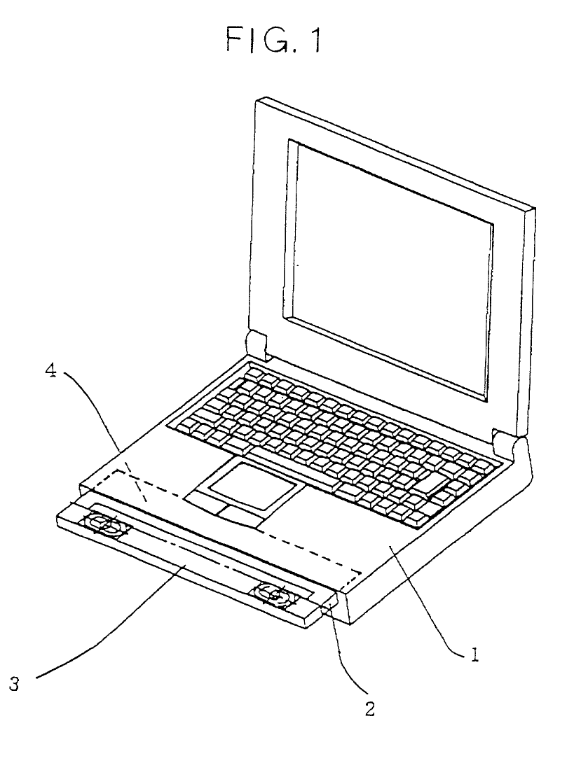

Referring to FIG. 1 of the drawings, a personal computer (PC hereinafter) embodying the present invention is shown and implemented as a notebook-sized PC by way of example. As shown, the PC is generally made up of a body 1, a retractable hinge unit 2, a speaker unit 3 connected to the hinge unit 2, and a speaker storing section 4 formed in the body 1 for receiving the speaker unit 3. The speaker unit 3 has a pair of speakers arranged face up therein, as illustrated.

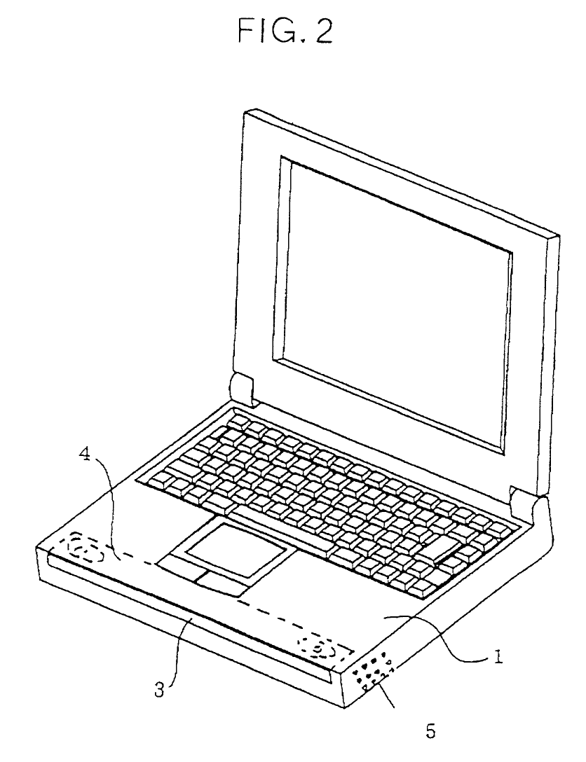

How the above PC is operated will be described with reference to FIGS. 2 through 4. As shown in FIG. 2, when the speaker unit 3 is received in the speaker storing section 4 of the body 1, sound is output via holes 5 formed in the opposite side walls of the body 1.

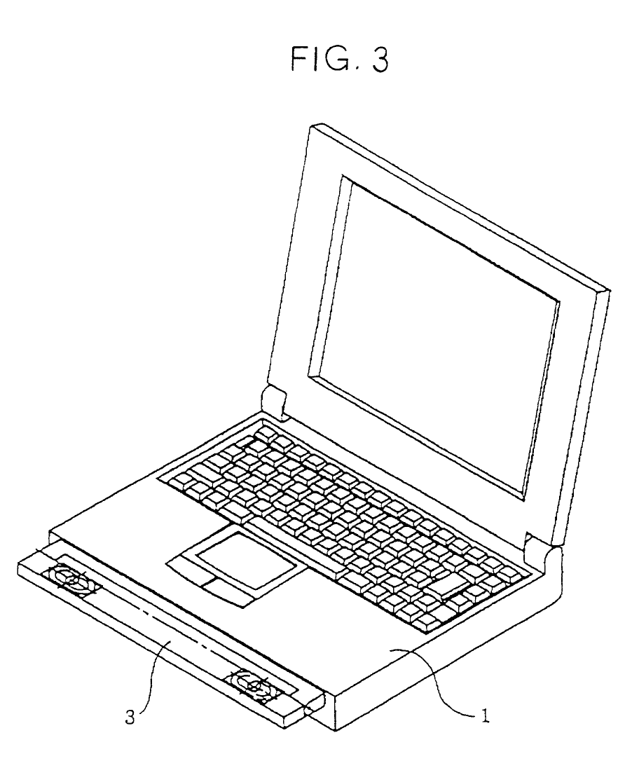

As shown in FIG. 3, when the operator of the PC pulls the speaker unit 3 out of the speaker storing section 4, sound is output upward from the speakers positioned face up. Sound output in this condition is clearer than in the condition of FIG. 2 in which the speaker unit 3 is retracted into the speaker storing section 4.

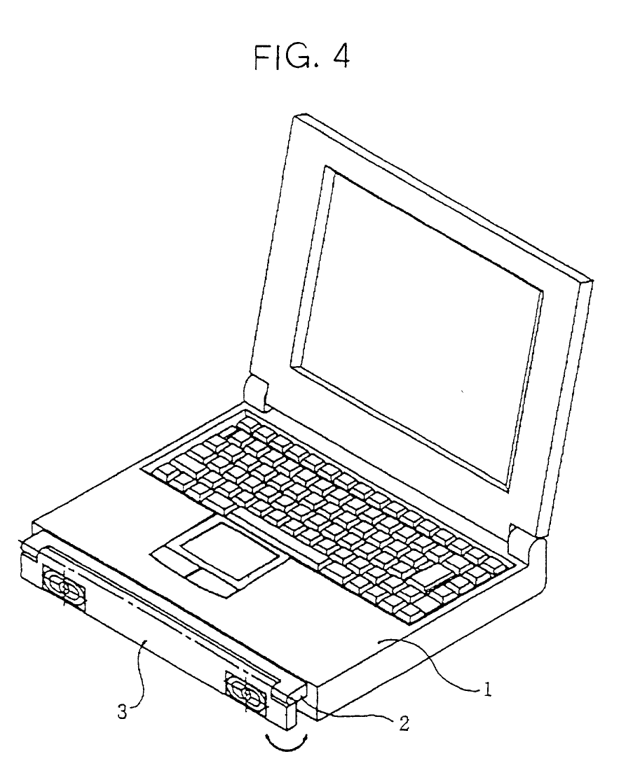

As shown in FIG. 4, the operator may change the angle of the speaker unit 3 connected to the hinge unit 2. Specifically, the hinge unit 2 includes a hinge or tilting mechanism, not shown, for allowing the speaker unit 3 to be adjusted to a desired angle by hand. For example, the operator may tilt the speaker unit 3 downward from the position of FIG. 3 by about 90 degrees about the above hinge mechanism, causing the speakers to face the front. That is, the operator is capable of adjusting the speaker unit 2 to an angle matching with the operating position and thereby hearing clearer sound.

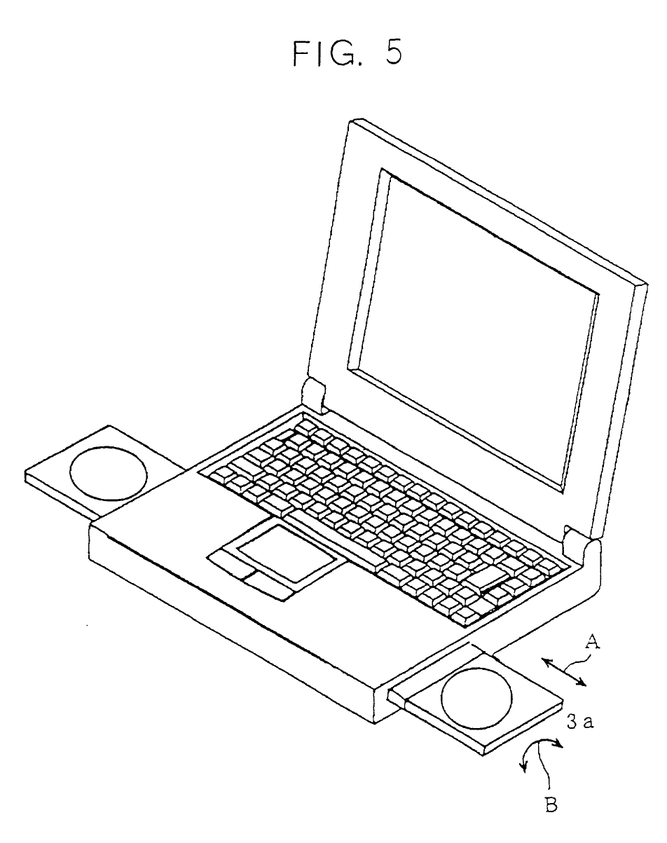

FIG. 5 shows an alternative embodiment of the present invention. As shown, a notebook-sized PC includes a pair of speaker units 3a slidable into and out of a PC body sideways. Specifically, the operator of the PC may pull the speaker units 3a out of the PC body via the sidewalls of the PC body, as indicated by a double-headed arrow A in FIG. 5. Further, the operator may adjust the angle of the speaker units 3a pulled out of the PC body, as indicated by a double-headed arrow B in FIG. 5. As for the rest of the construction, this embodiment is identical with the previous embodiment.

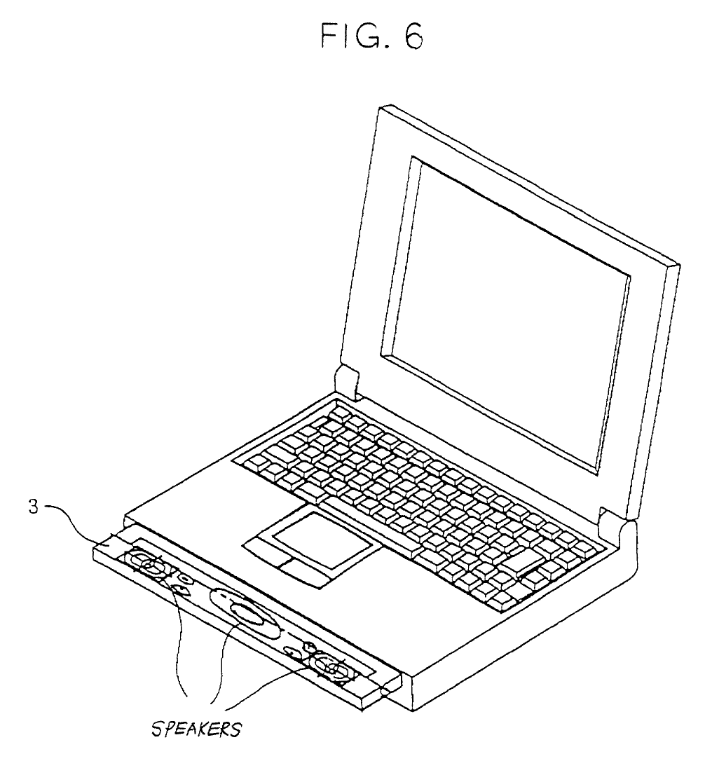

Another alternative embodiment of the present invention is shown in FIG. 6. As shown, a plurality of speakers are arranged in the speaker unit 3 at spaced locations in the right-and-left direction of the speaker unit 3 as viewed in FIG. 6. With this configuration, the illustrative embodiment is capable of outputting clearer sound than the previous embodiments.

In summary, a PC of the present invention includes retractable speakers and allows them to be adjusted to a desired angular position by hand. The speakers can therefore be mounted on the PC face up and promote the thin configuration of the PC without regard to their diameter. Because holes for outputting sound are absent in the top wall of the PC, there can be obviated an occurrence that the operator inadvertently stops such holes or that impurities including dust enter the PC via the holes. Further, the operator pulled out the speakers can ti It them to a desired angle for hearing clearer sound.

Various modifications will become possible for those skilled in the art after receiving the teachings of the present disclosure without departing from the scope thereof.

What is claimed is:

1. A personal computer with a speaker, comprising:
a body;
a speaker storing section formed in said body for receiving said speaker;
a hinge unit retractable into said speaker storing section; and
a speaker unit including said speaker and connected to said hinge unit by a hinge mechanism such that said speaker is retractable into said speaker storing section together with said hinge unit.

2. A personal computer as claimed in claim 1, wherein said speaker unit is capable of being pulled out of said speaker storing section and then tilted to a desired angle via said hinge mechanism.

3. A personal computer as claimed in claim 2, wherein holes are formed in part of said body such that said speaker unit is usable even when retracted into said speaker storing section.

4. A personal computer as claimed in claim 3, wherein said speaker unit includes at least two speakers.

5. A personal computer as claimed in claim 4, wherein said speaker unit is capable of being pulled out to a front of said body.

6. A personal computer as claimed in claim 4, wherein said speaker unit is capable of being pulled out to a side of said body.

7. A personal computer as claimed in claim 6, wherein said personal computer comprises a notebook-sized computer.

8. A personal computer as claimed in claim 1, wherein holes are formed in part of said body such that said speaker unit is usable even when retracted into said speaker storing section.

9. A personal computer as claimed in claim 1, wherein said speaker unit includes at least two speakers.

10. A personal computer as claimed in claim 1, wherein said speaker unit is capable of being pulled out to a front of said body.

11. A personal computer as claimed in claim 1, wherein said speaker unit is capable of being pulled out to a side of said body.

12. A personal computer as claimed in claim 1, wherein said personal computer comprises a notebook-sized computer.
